(19) United States
(12) Patent Application Publication
(10) Pub. No.: US 2009/0255127 A1
(43) Pub. Date: Oct. 15, 2009

(54) UTILITY KNIFE MULTI-TOOL

(76) Inventors: Daniel R. Seymour, Mooresville, NC (US); Brandon C. Hoover, Cornelius, NC (US); James M. Burry, Troutman, NC (US)

Correspondence Address: RONALD L. HOFER, 122 LINDBERGH LANE, MOORESVILLE, NC, 28117, US

(21) Appl. No.: 12/421,080

(22) Filed: Apr. 9, 2009

Related U.S. Application Data
(60) Provisional application No. 61/123,446, filed on Apr. 9, 2008.

(51) Int. Cl. B26B 3/06

(52) U.S. Cl. 30/161

(57) ABSTRACT

A utility knife multi-tool carries a razor blade as a primary cutting blade. The tool has a handle and a blade. The blade has a flat body with an edge and a flat, each of which have grooves cut therein to provide file, rasp or saw functionality for the blade. The forward end of the blade is pointed and carries a razor blade. The multi-tool has a handle with a striking cap at an end thereof and can have a storage tray for holding at least one spare cutting blade and a folding blade with a blade lock mechanism in the handle to releasably lock the blade in operating position.

### FIELD OF THE INVENTION

The present invention relates to a utility knife multi-tool. More particularly, a preferred embodiment of the present invention relates to a folding utility knife multi-tool with a quick change cutting blade in combination with a file or rasp, a saw, a striking cap and a blade storage tray.

### BACKGROUND OF THE INVENTION

Utility knives are used in many different industries. These useful tools, which are sometimes referred to as box cutters or carpet knives, generally consist of an inexpensive handle and a blade holder which holds a replaceable blade. Some utility knives are “folding,” i.e., they have a blade holder which can be pivoted into the handle when the blade is not in use to cover the cutting edge of the blade.

In the construction industry utility knives are used to cut a variety of materials and have proven to be particularly useful to cut sheets of drywall which is also known as wallboard. The procedure for cutting a sheet of drywall usually involves first cutting or scoring the sheet and then snapping the sheet along the cut to separate the sheet into two pieces. While this technique works well and is almost universally used, it is often found that the cut edge of drywall sheet is a jagged edge. A second tool, such as a file or a rasp, must be used to file the edge until it is clean. Of course, the utility knife which had been used to make the cut must be put aside to pick up the file or rasp to complete the job. It would be desirable if one had a single tool which could be used to both cut a sheet of drywall and file the edge of the cut to complete the job.

It is also common in the construction industry for a person working with materials such as drywall or linoleum to encounter a nail which is not completely set in the drywall or material around a nail or screw which has “mushroomed” out of the adjacent surface. When this occurs, the person must use a hammer or other suitable tool to drive the nail or mushroom into the wall. It would be desirable if the person already had the tool in hand to take care of the nail set or mushroom without reaching for a new tool.

Thus, it would be desirable to have a single tool which combines the functions of a knife, a file or rasp, a saw and a hammer. Such a tool would facilitate the cutting and finishing of many materials, in particular, the cutting and finishing of drywall. Heretofore the cutting and finishing of drywall has required the use of four tools: a knife, a file or rasp, a saw, and a hammer. Accordingly, the present invention provides a multi-function utility knife which can function as a knife, a file or rasp, a saw and a hammer. In use, the present invention allows a workman to handle up to four different tasks without picking up different tools. Of course, while the hand tool of the present invention is particularly useful in cutting drywall, it will be appreciated by those skilled in the art that the tool is also well suited for use with a wide variety of other materials.

These and other advantages of the present invention will be apparent from the following description of preferred embodiments of the invention taken in conjunction with the accompanying drawings and following claims.

### SUMMARY OF THE INVENTION

The folding utility knife multi-tool of this invention is a hand tool which carries a razor blade as a primary cutting blade. The utility knife multi-tool has a handle assembly and a blade assembly. In a preferred embodiment of the present invention, the blade assembly is pivotally attached to the handle assembly which has a hollow interior into which the blade assembly can be pivoted for storage. The blade assembly has a flat body with an edge and a flat, each of which has grooves cut therein to provide file or rasp functionality for the blade and optionally a saw functionality. The forward end of the blade assembly carries a razor blade for cutting purposes. In another preferred embodiment, the multi-tool has a handle assembly with a striking cap at a rear end thereof and a blade assembly pivotally attached to the handle assembly, the blade assembly having a flat body with an edge formed into a saw and a side formed into a file or rasp and a forward end portion carrying a razor blade. In another preferred embodiment of the tool, a tray is provided in the handle assembly to carry at least one spare cutting blade and a blade lock mechanism is provided in the handle assembly to releasably lock the blade mechanism into operating position.

### DETAILED DESCRIPTION OF THE DRAWINGS

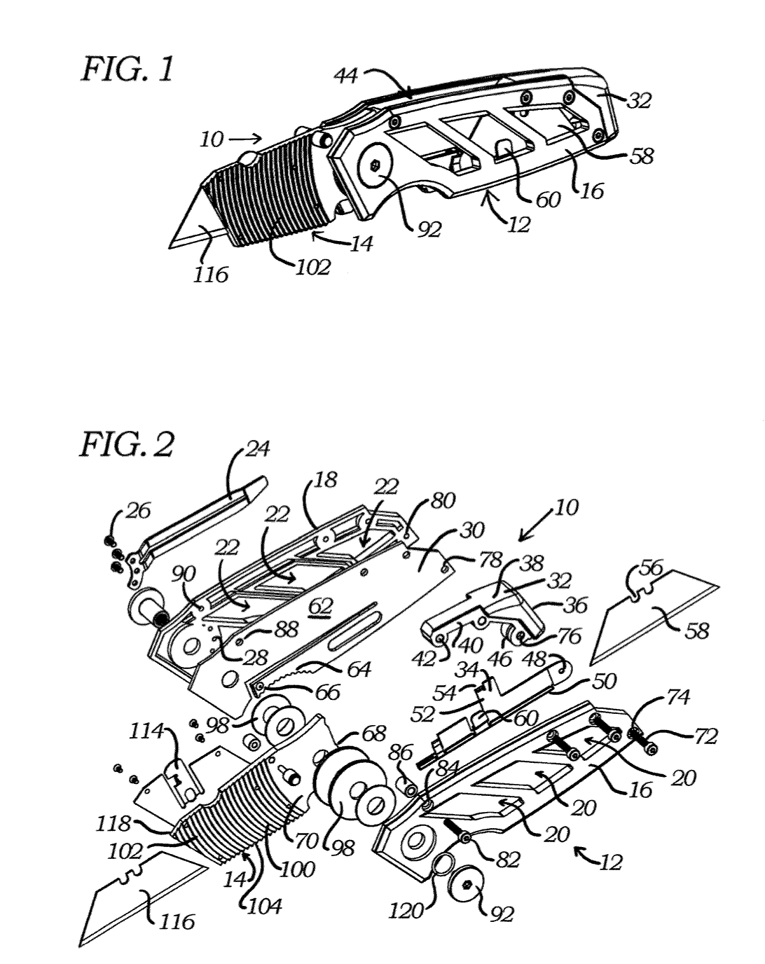

FIG. 1 is left perspective view of a preferred embodiment of a folding utility knife multi-tool of the present invention with its blade mechanism in an opened configuration and the blade storage tray in a closed configuration;

FIG. 2 is a left side exploded view of the tool of FIG. 1 showing the individual components thereof;

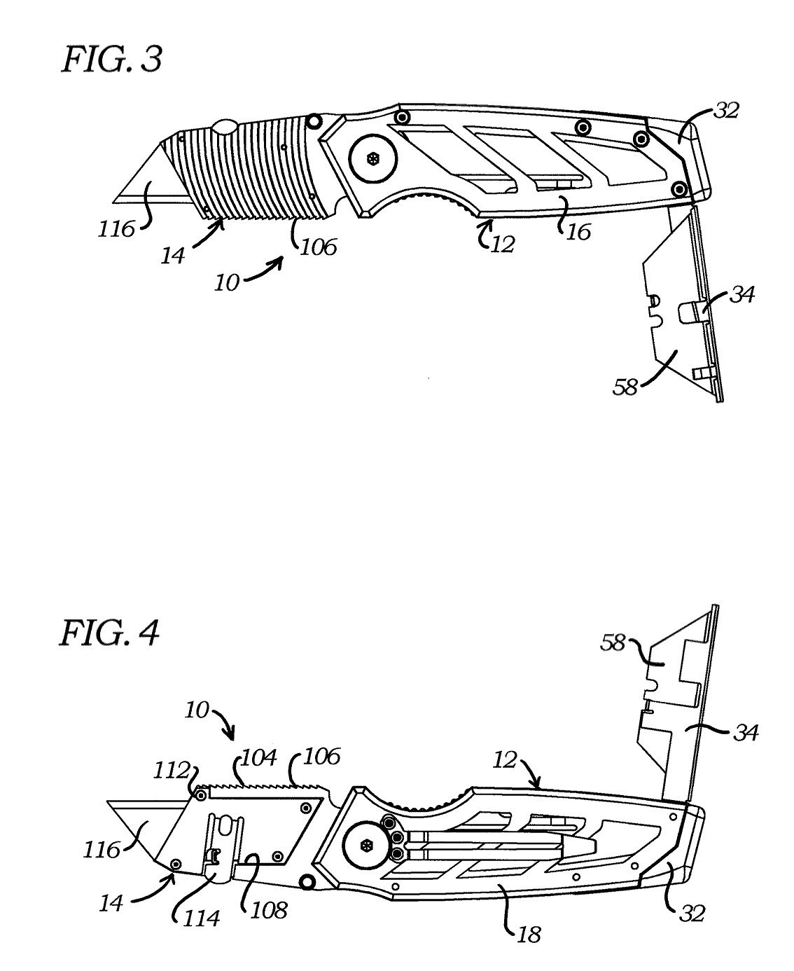

FIG. 3 is a left side elevational view of the tool of FIG. 1 but showing both the blade mechanism and blade storage tray in an opened configuration;

FIG. 4 is a right side elevational view of the tool of FIG. 1 in the configuration of FIG. 3, with the knife having been rotated 180 degrees about its longitudinal axis;

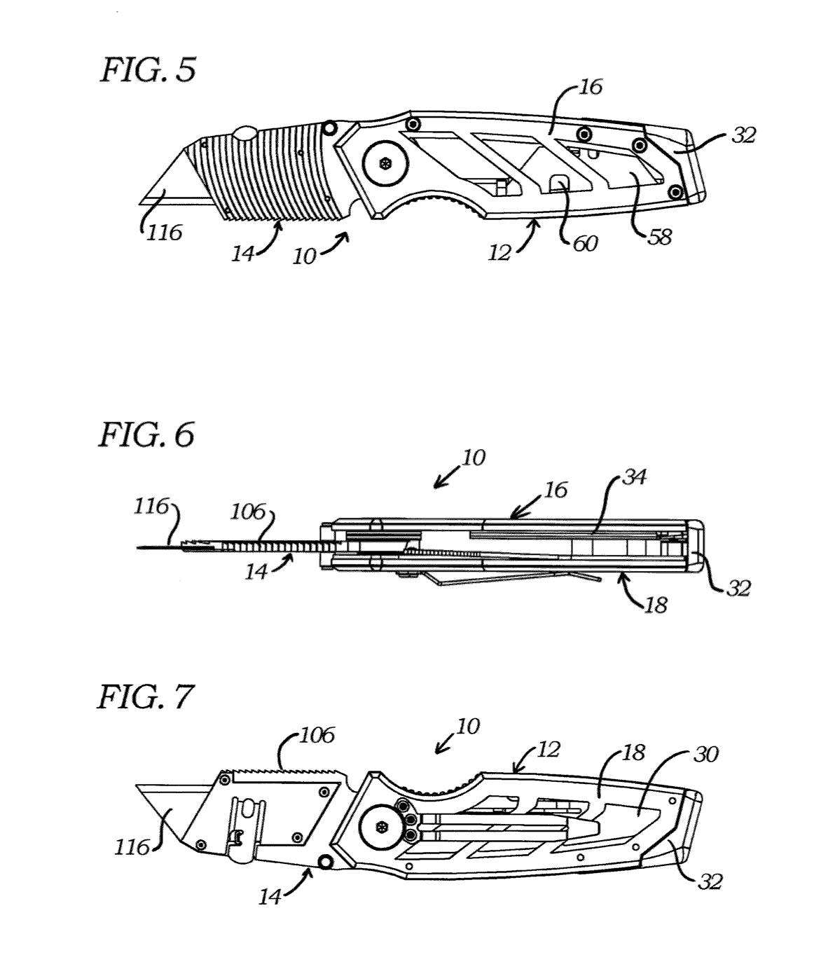

FIG. 5 is a left side elevational view of the tool of FIG. 1 showing the blade mechanism in an open configuration and the blade storage tray in a closed configuration;

FIG. 6 is a plan view of the tool of FIG. 1 in the configuration of FIG. 5;

FIG. 7 is a right side elevational view of the tool of FIG. 1 in the configuration of FIG. 5 with the knife having been rotated 180 degrees about its longitudinal axis;

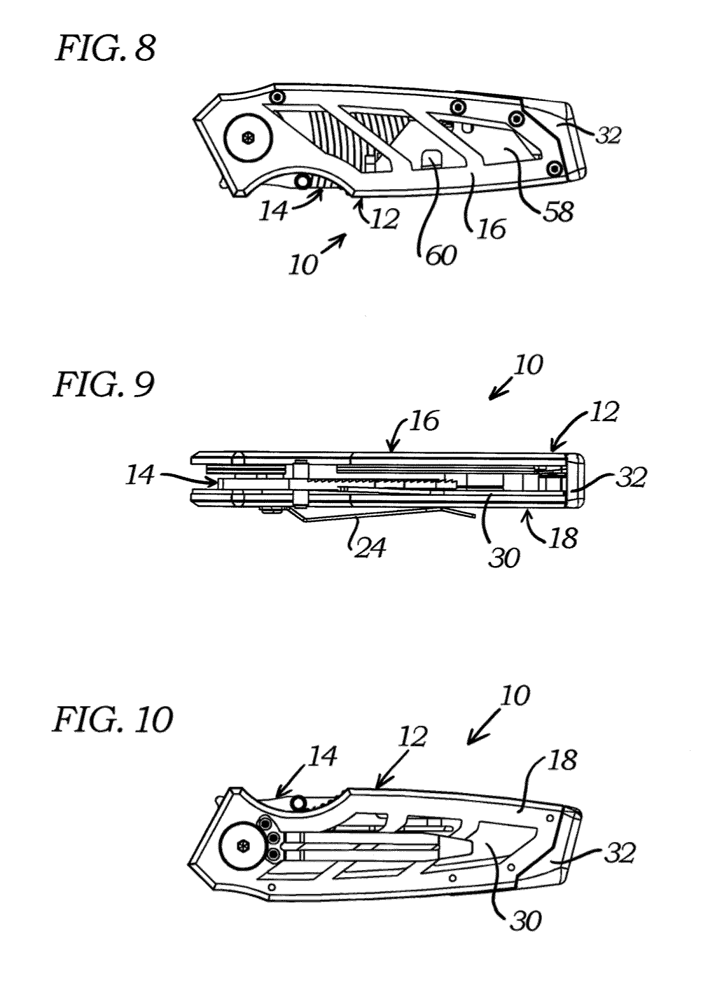

FIG. 8 is a left side elevational view of the tool of FIG. 1 with blade mechanism and blade storage tray both in closed configuration;

FIG. 9 is a plan view of the tool of FIG. 1 in the configuration of FIG. 8; and

FIG. 10 is a right side elevational view of the tool of FIG. 1 in the configuration of FIG. 8 with the knife having been rotated 180 degrees about its longitudinal axis.

### DESCRIPTION OF THE INVENTION

Now referring to FIGS. 1-10, a preferred embodiment of a folding utility knife multi-tool of the present invention is shown and indicated generally by the numeral 10. Generally speaking, tool 10 comprises handle assembly 12 and blade assembly 14, each of which is described in detail below.

Handle assembly 12 has first body half 16 and second body half 18, one body half being generally a mirror image of the other body half. First body half 16 and second body half 18 have open spaces 20 and 22 respectively to reduce the weight of handle assembly 12 and to improve the aesthetics of tool 10 and are fastened together in the manner disclosed in the following paragraphs to hold and contain other elements of handle assembly 12 as well as blade assembly 14. A pocket clip 24 is attached to second body half 18 by a plurality of threaded fasteners 26 which threadably engage holes 28 in second body half 18. Pocket clip 24 is preferably made of spring steel or the like and is useful for attaching tool 10 to a pocket of a user.

Handle assembly 12 has, located generally between first and second body halves 16 and 18, blade lock mechanism 30, striking cap 32, and blade storage tray 34. Body halves 16 and 18 can be made of aluminum, plastic, or other suitable materials. Blade lock mechanism 30 and striking cap 32 are preferably made of steel but can be made of any material which is found to be suitable for their respective functions.

Striking cap 32 has rearwardly facing striking face 36 and an upwardly facing alternate striking face 38 which are adapted for driving nails, staples or the like. Striking cap 32 also has forwardly extending, reduced thickness neck 40 with holes 42 therethrough. Forwardly extending neck 40 secures striking cap 32 to body halves 16 and 18 and has a width to space the body halves apart to provide an interior space 44 to contain blade assembly 14, blade lock mechanism 30 and blade storage tray 34. Slot 46 is provided to receive ear 48 of blade storage tray 34.

Blade storage tray 34 has a channel 50 and a spring clip portion 52 with tang 54, which cooperate to hold a conventional trapezoidal razor blade 56 in position as is best shown in FIGS. 3 and 4. Blade storage tray 34 is spring biased toward first body half 16 to provide adequate clearance for storage of blade mechanism 14 in the interior of handle assembly 12 and is spaced from first body half by spacer tab 60 which also provides friction which must be overcome by the user to pivot blade storage tray 34 out of handle assembly 12 to remove razor blade 56 therefrom.

Blade lock mechanism 30 is a planar spring steel sheet member 62 with finger 64 bent toward first body half 16. Finger 64 is normally not coplanar with sheet member 62 and assumes a locking position with its forward end 66 abutting against rearward end 68 of blade member 70 to lock blade assembly 14 in its operating position as shown in FIGS. 1-7. Blade lock mechanism 30. Forward end 66 of finger 64 can be manipulated toward second body half 18 to unlock blade assembly 14 to thereby allow pivotal movement of blade assembly 14 to its stored position as shown in FIGS. 8-10.

First body half 16 is fastened to second body half 18 and handle assembly 12 and its various parts are secured thereto by means of a plurality of cap screws 72 which extend through holes 74 in first body half 16, holes 76 in striking cap 32, holes 78 in steel sheet member 62 and into threaded holes 80 in second body half 18. Forward cap screw 82 extends through hole 84 in first body half 16, through tubular spacer 86, through hole 88 in steel sheet member 62 and into threaded hole 90 in second body half 18. First body half 16 is also fastened to second body half 18 by male pivot screw 92 which is received in female pivot screw 94 which also serve to secure blade assembly 14 to handle assembly 12. O-ring 120 provides friction to improve the feel of the blade when it is being pivoted. A plurality of washers 98 are provided to facilitate pivotal movement of blade assembly 14 with respect to handle assembly 12.

Blade assembly 14 has a steel blade member 70 with left side face 100 having grooves 102 cut therein to function as a rasp while edge 104 of blade member 70 has grooves 106 cut therein to function as a file. The right side of blade member 70 has a cut out portion 108 which is sized to receive a flat insert 110 which is fastened to blade member 70 by a plurality of screws 112. Insert 110 has a spring clip 114 which retains a conventional trapezoidal shaped razor blade 116 between blade member 70 and insert 110. Razor blade 116 can, be released by a user manipulating spring clip 114. The forward end of steel blade member 70 is shaped into a point 118 which can be used as a punch tool or jab saw after blade 116 has been removed.

It will be appreciated by those skilled in the art that the present invention offers many advantages. The present invention provides a multi-function tool having a steel blade with a rasp surface texture and a file edge, along with a quick change razor blade, blade storage in the handle, and a striking cap. The steel blade is attached to the handle by a substantial pivot point allowing it to fold into the handle for storage. The blade can be heat treated and machined, formed or rolled with an aggressive file texture on one side and both upper and lower edges. The file can be used to clean up any jagged edges of the materials which have been cut. The blade is formed into a tip which can be helpful for jabbing holes. A quick change razor blade system is located at the end of the steel blade and used as the primary cutting tool. A blade storage tray is attached to the handle by a pivot point and locks inside the handle. Finally a removable pocket clip is attached to the back side of the handle.

The folding multi-function knife of the present invention has many desired features which will be useful to end users in cutting variety of different materials, including drywall. It does not require outside power sources and can be used anywhere. It solves the problem of having to have multiple tools to complete the job of cutting, filing and hanging drywall. It offers a folding mechanism with blade storage. The present invention meets the need for a tool to cut a variety of materials without the use of power and a combination of required tools.

While a preferred embodiment of a tool of the present invention has been disclosed and described above, it will be appreciated by those skilled in the art that the present invention is subject to modifications and variations. For example, the blade assembly maybe fixedly attached to the handle assembly or slidingly attached thereto. Also, the blade assembly may have an edge with saw teeth or file grooves or a combination of both. The blade assembly and handle assembly can be made of several different materials so long as the materials are consistent with the function of the present invention. For example, stainless steel can be used instead of spring steel. Such modifications and variations are within the spirit of the present invention which is intended to be limited only by the following claims. The screws threaded holes can be replace with bolts and nuts.

What is claimed is:

1. A utility knife comprising a handle assembly and a blade assembly,
said handle assembly having a forward portion and a rearward portion; and
said blade assembly having an elongated flat blade member said blade member carrying a removable cutting blade, and said blade member having a body with an edge having grooves cut therein and a flat face having grooves cut therein.

2. A utility knife as in claim 1 wherein said handle assembly carries a striking cap on said rearward portion thereof.

3. A utility knife as in claim 1 wherein said handle assembly has a hollow interior.

4. A utility knife as in claim 2 wherein said blade assembly is pivotally attached to said forward portion of said handle assembly and is adapted to pivot between an operable position outside of said hollow interior of said handle assembly and a storage position substantially within said hollow interior.

5. A utility knife as in claim 2 wherein said handle assembly has a blade tray pivotally attached to said handle assembly and adapted to carry a spare blade in said hollow interior of said handle assembly.

6. A utility knife as in claim 2 wherein said utility knife has a blade lock mechanism located in said hollow interior of said handle assembly.

7. A utility knife having:
a handle assembly with a rearward portion having a striking cap thereon, said striking cap having at least two substantially planar striking faces; and
a blade assembly, said blade assembly having an elongated flat blade member said blade member carrying a removable cutting blade, and said blade member having a body with an edge having grooves cut therein and a flat face having grooves cut therein.

8. A utility knife as in claim 7, wherein said handle assembly has a hollow interior and said blade assembly is pivotally attached to said forward portion of said handle assembly and is adapted to pivot between an operable position outside of said hollow interior of said handle assembly and a storage position substantially within said hollow interior.
